(19) United States
(12) Patent Application Publication
(10) Pub. No.: US 2016/0171569 A1
(43) Pub. Date: Jun. 16, 2016

(54) UNIFIED CONTENT DELIVERY PLATFORM

(71) Applicant: Atlas Advisory Partners, LLC, Hoboken, NJ (US)

(72) Inventors: Richard E. Gideon, Princeton, NJ (US); Marie Jannone, Morristown, NJ (US)

(21) Appl. No.: 15/049,763

(22) Filed: Feb. 22, 2016

Related U.S. Application Data
(63) Continuation of application No. 14/708,835, filed on May 11, 2015, now abandoned.
Application No. 14/708,835 is a continuation of application No. 13/187,811, filed on Jul. 21, 2011, now abandoned.
(60) Provisional application No. 61/502,022, filed on Jun. 28, 2011.
(60) Provisional application No. 61/492,997, filed on Jun. 3, 2011.
(60) Provisional application No. 61/367,541, filed on Jul. 26, 2010.
(60) Provisional application No. 61/471,948, filed on Apr. 5, 2011.
(60) Provisional application No. 61/367,536, filed on Jul. 26, 2010.

(51) Int. Cl. G06Q 30/04; G06Q 30/02; H04L 29/08

(52) U.S. Cl. CPC G06Q 30/04; H04L 67/10; G06Q 30/0251

(57) ABSTRACT

A computer-implemented uniform content delivery platform (UCDP) comprising a network interface for receiving content from suppliers and delivering content to consumers, a content storage for storing the content, storage for consumer information, consumer device information, delivery option data and information of content deliveries. The UCDP also comprises a content delivery transaction monitor and an analysis engine for analyzing transaction data. The UCDP uses the transaction data to charge content consumers, pay content suppliers, and modify content delivery options.

### CROSS-REFERENCE TO RELATED APPLICATION

This application claims the benefit of priority to U.S. Application Ser. No. 61/502,022, filed Jun. 28, 2011, entitled Unified Content Delivery Platform; U.S. Ser. No. 61/492,997, filed Jun. 3, 2011, entitled Unified Content Delivery Platform; U.S. Ser. No. 61/367,541, filed Jul. 26, 2010, entitled Unified Content Delivery Platform; and is related to U.S. Application Ser. No. 61/471,948, filed Apr. 5, 2011, entitled Passive Demographic Measurement Apparatus; U.S. Application Ser. No. 61/367,536, filed Jul. 26, 2010, entitled Passive Demographic Measurement Apparatus; each of which applications is incorporated herein by reference as if set forth herein in its respective entirety.

### BACKGROUND

The proliferation of technology such as PCs, e-tablets and smart phones has created a desire among consumers to access audio, video, electronic document content and the like on demand. However, such content are accessed from many different sources, which presents obstacles to content producers and owners to fully monetizing the value of the content being accessed. There is a need for a unified content delivery platform to deliver many different types of content, accessible via many different technologies, by a plurality of devices of various kinds. Such a platform would be beneficial to consumers, who would enjoy easier and more unified access, and to content producers, owners, and providers, who would have new opportunities to monetize their content.

### SUMMARY

A computer-implemented unified content delivery platform and method are disclosed for providing access to a plurality of types of digital content, including but not limited to video, audio, and document content, and for delivery of the accessed content to consumers. The service comprises user interfaces with a consistent presentation across different access modalities, which together provide to a consumer a user experience of accessing the content from a single source, regardless of the type of content being accessed or the devices used to access it. Thereby, a “one-source” shopping, access, and delivery experience is provided to the subscriber. Various pricing methods can be used to provide content creators, owners, and publishers with more effective monetization of the value of their content than was previously possible, creating enhanced and/or additional revenue streams.

It is to be understood that both the foregoing general description and the following detailed description are exemplary and explanatory, and are intended to provide further explanation of the invention as claimed.

### BRIEF DESCRIPTION OF THE DRAWINGS

The accompanying drawings are included to provide a further understanding of the disclosed embodiments. In the drawings:

FIG. 1 is a block diagram of an exemplary computing system for use in accordance with herein described systems and methods.

FIG. 2 is a block diagram showing an exemplary networked computing environment for use in accordance with herein described systems and methods.

FIG. 3 is a block diagram showing devices operated by cooperating parties in an illustrative arrangement in accordance with herein described systems and methods.

FIG. 4 is a block diagram showing cooperating parties using an exemplary unified content delivery platform in accordance with herein described systems and methods.

FIG. 5 is a flow diagram of an exemplary method for use in accordance with herein described systems and methods.

### DETAILED DESCRIPTION

A computer-implemented unified content delivery platform and methods of use are disclosed for providing access to a plurality of types of digital content, including but not limited to video, audio, and document content, and for delivery of the accessed content to consumers. Described embodiments are intended to be exemplary and not limiting. As such, it is contemplated that the herein described systems and methods can be adapted to provide many types of users with access and delivery of many types of digital content, and can be extended to provide enhancements and/or additions to the exemplary services described. The claims are intended to include all such extensions.

Reference will now be made in detail to various exemplary and illustrative embodiments of the present invention.

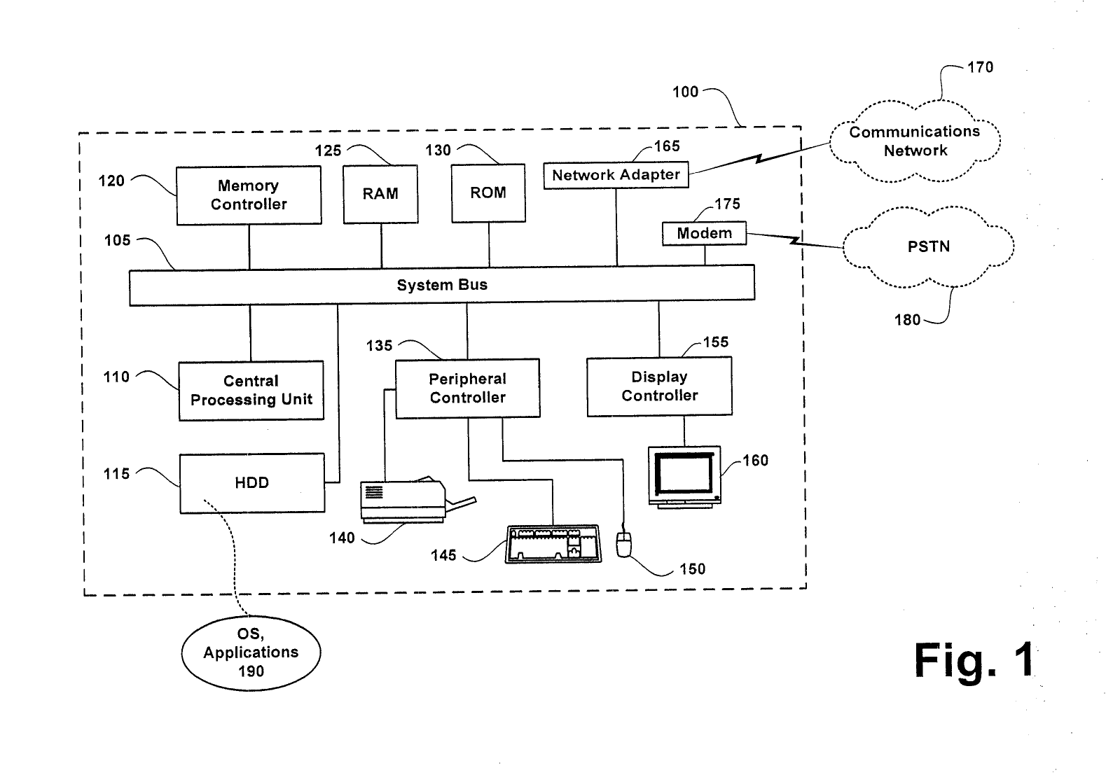

FIG. 1 depicts an exemplary computing system 100 that can be used in accordance with herein described system and methods. Computing system 100 is capable of executing software, such as an operating system (OS) and a variety of computing applications 190. The operation of exemplary computing system 100 is controlled primarily by computer readable instructions, such as instructions stored in a computer readable storage medium, such as hard disk drive (HDD) 115, optical disk (not shown) such as a CD or DVD, solid state drive (not shown) such as a USB “thumb drive,” or the like. Such instructions may be executed within central processing unit (CPU) 110 to cause computing system 100 to perform operations. In many known computer servers, workstations, personal computers, and the like, CPU 110 is implemented in an integrated circuit called a processor.

It is appreciated that, although exemplary computing system 100 is shown to comprise a single CPU 110, such description is merely illustrative as computing system 100 may comprise a plurality of CPUs 110. Additionally, computing system 100 may exploit the resources of remote CPUs (not shown), for example, through communications network 170 or some other data communications means.

In operation, CPU 110 fetches, decodes, and executes instructions from a computer readable storage medium such as HDD 115. Such instructions can be included in software such as an operating system (OS), executable programs, and the like. Information, such as computer instructions and other computer readable data, is transferred between components of computing system 100 via the system's main data-transfer path. The main data-transfer path may use a system bus architecture 105, although other computer architectures (not shown) can be used, such as architectures using serializers and deserializers (serdes) and crossbar switches to communicate data between devices over serial communication paths. System bus 105 can include data lines for sending data, address lines for sending addresses, and control lines for sending interrupts and for operating the system bus. Some busses provide bus arbitration that regulates access to the bus by extension cards, controllers, and CPU 110. Devices that attach to the busses and arbitrate access to the bus are called bus masters. Bus master support also allows multiprocessor configurations of the busses to be created by the addition of bus master adapters containing processors and support chips.

Memory devices coupled to system bus 105 can include random access memory (RAM) 125 and read only memory (ROM) 130. Such memories include circuitry that allows information to be stored and retrieved. ROMs 130 generally contain stored data that cannot be modified. Data stored in RAM 125 can be read or changed by CPU 110 or other hardware devices. Access to RAM 125 and/or ROM 130 may be controlled by memory controller 120. Memory controller 120 may provide an address translation function that translates virtual addresses into physical addresses as instructions are executed. Memory controller 120 may also provide a memory protection function that isolates processes within the system and isolates system processes from user processes. Thus, a program running in user mode can normally access only memory mapped by its own process virtual address space; it cannot access memory within another process' virtual address space unless memory sharing between the processes has been set up.

In addition, computing system 100 may contain peripheral controller 135 responsible for communicating instructions using a peripheral bus from CPU 110 to peripherals, such as printer 140, keyboard 145, and mouse 150. An example of a peripheral bus is the Peripheral Component Interconnect (PCI) bus.

Display 160, which is controlled by display controller 155, can be used to display visual output generated by computing system 100. Such visual output may include text, graphics, animated graphics, and/or video, for example. Display 160 may be implemented with a CRT-based video display, an LCD-based flat-panel display, gas plasma-based flat-panel display, touch-panel, or the like. Display controller 155 includes electronic components required to generate a video signal that is sent to display 160.

Further, computing system 100 may contain network adapter 165 which may be used to couple computing system 100 to an external communication network 170, which may include or provide access to the Internet. Communications network 170 may provide user access to computing system 100 with means of communicating and transferring software and information electronically. For example, users may communicate with computing system 100 using communication means such as email, direct data connection, virtual private network (VPN), Skype or other online video conferencing services, or the like. Additionally, communications network 170 may provide for distributed processing, which involves several computers and the sharing of workloads or cooperative efforts in performing a task. It is appreciated that the network connections shown are exemplary and other means of establishing communications links between computing system 100 and remote users may be used.

Computing system 100 may also contain modem 175 which may be used to couple computing system 100 to a telephone communication network, such as the public switched telephone network (PSTN) 180. PSTN 180 may provide user access to computing system 100 via so-called Plain Old Telephone Service (POTS), Integrated Services Digital Network (ISDN), mobile telephones, Voice over Internet Protocol (VoIP), video telephones, and the like. It is appreciated that the modem connections shown are exemplary and other means of establishing communications links between computing system 100 and remote users may be used.

It is appreciated that exemplary computing system 100 is merely illustrative of a computing environment in which the herein described systems and methods may operate and does not limit the implementation of the herein described systems and methods in computing environments having differing components and configurations, as the inventive concepts described herein may be implemented in various computing environments using various components and configurations.

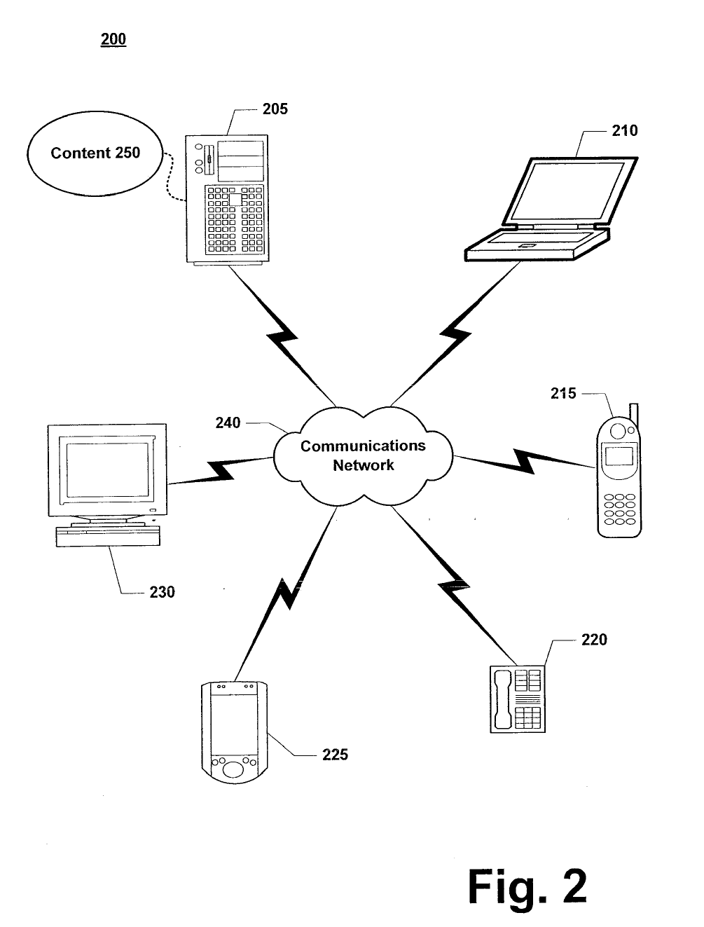

As shown in FIG. 2, computing system 100 can be deployed in networked computing environment 200. In general, the above description for computing system 100 applies to server, client, and peer computers deployed in a networked environment, for example, server 205, laptop computer 210, and desktop computer 230. FIG. 2 illustrates an exemplary illustrative networked computing environment 200, with a server in communication with client computing and/or communicating devices via a communications network, in which the herein described apparatus and methods may be employed.

As shown in FIG. 2, server 205 may be interconnected via a communications network 240 (which may include any of, or any combination of, a fixed-wire or wireless LAN, WAN, intranet, extranet, peer-to-peer network, virtual private network, the Internet, or other communications network such as POTS, ISDN, VoIP, PSTN, etc.) with a number of client computing/communication devices such as laptop computer 210, wireless mobile telephone 215, wired telephone 220, personal digital assistant 225, user desktop computer 230, and/or other communication enabled devices (not shown). Server 205 can comprise dedicated servers operable to process and communicate data such as digital content 250 to and from client devices 210, 215, 220, 225, 230, etc. using any of a number of known protocols, such as hypertext transfer protocol (HTTP), file transfer protocol (FTP), simple object access protocol (SOAP), wireless application protocol (WAP), or the like. Additionally, networked computing environment 200 can utilize various data security protocols such as secured socket layer (SSL), pretty good privacy (PGP), virtual private network (VPN) security, or the like. Each client device 210, 215, 220, 225, 230, etc. can be equipped with an operating system operable to support one or more computing and/or communication applications, such as a web browser (not shown), email (not shown), or the like, to interact with server 205.

In conventional content delivery systems such as newspapers, magazines, television, radio, movie theaters, and the like, substantive content is delivered to viewers, such as articles, stories, shows, movies, and the like. In addition, often collateral content such as advertising is delivered to the viewers in conjunction with the substantive content. There are many different common business models for generating revenue in conjunction with delivering the content to viewers. Such models include charging viewers only for the substantive content (common, for example, in providing books and movies); providing the content at no cost to the viewers and soliciting donations (such as in public radio and television broadcasting); providing content at no cost to the viewer and charging advertisers for placing advertisements delivered in conjunction with the substantive content (such as commercial radio and television, Internet search engines, and the like); providing content for a monthly subscriber fee (such as cable and satellite television), or a one-time subscriber fee (such as pay-per-view and video on demand), etc. Subscriber content may be provided with or without advertising. These and other revenue models can be used with the herein described unified content delivery platform.

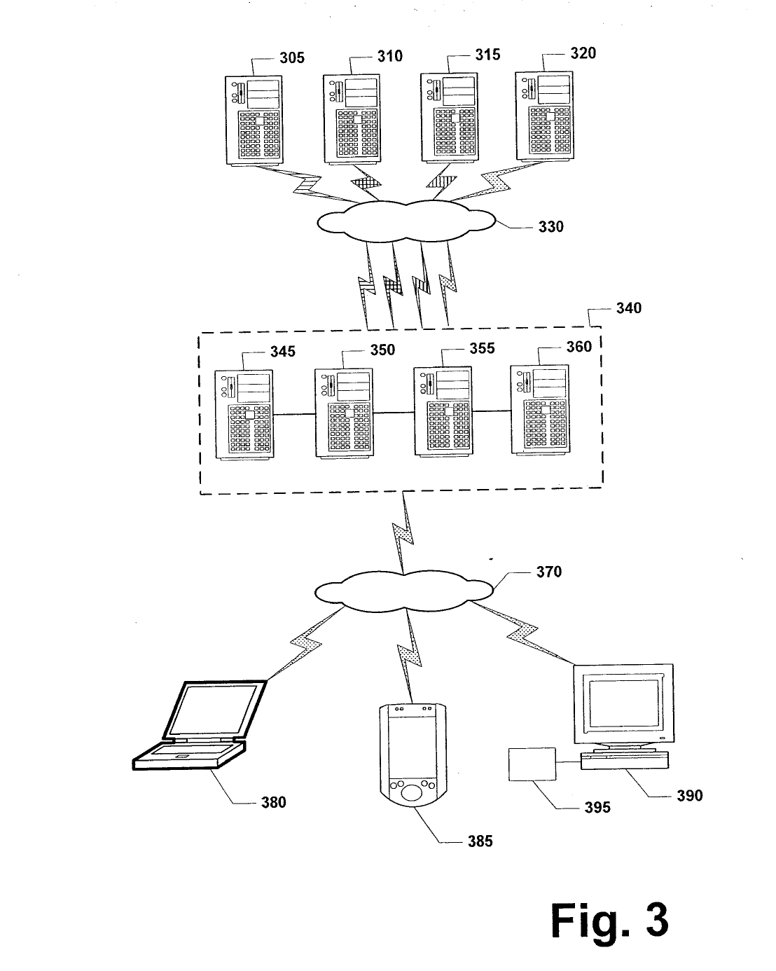

Referring now to FIG. 3, exemplary content suppliers 305, 310, 315, and 320 supply content for delivery to users. The content suppliers can include, for example, content creators, such as authors, artists, musicians, directors, and the like. Content suppliers can also include content owners who are not the creators, but have acquired ownership of the created content. Such content owners can include, for example, publishers, investors, producers, etc. Content may be supplied directly by the creators and owners, or indirectly through intermediaries, for example in accordance with agreements negotiated by agents representing the content creators. In addition, collateral content, such as advertising content, public service announcements, and other promotional material can be supplied by advertisers, community organizations, and the like.

The content suppliers supply different types of content to uniform content delivery platform (UCDP) 340, represented by communication “bolts” having different patterns. For example, horizontal hatching, such as that coupling supplier 305 with UCDP 340, can be used to indicate supplying an electronic book by an author or publisher. Cross hatching can indicate supply of a streaming music performance by a performer or record label. Vertical hatching can indicate supplying a pay-per-view sporting event by a promoter. A dotted pattern can indicate supplying a movie by a production company.

The content is supplied to UCDP 340, for example over network 330, which may include the Internet and/or other networks such as private high-speed wired or wireless communication links. UCDP 340 can include storage devices for storing supplied content, supplier data, consumer data, and the like. UCDP 340 can also include a monitored pass-through for provisioning and tracking supplied content, such as a live streaming pay-per-view event from a promoter's equipment to consumer viewing devices. UCDP 340 can also include mechanisms for defining, implementing, analyzing, and modifying various schemes for generating revenue associated with the supplied content, including the business models described previously, or select aspects thereof. UCDP 340 can include one or more components such as computers and storage devices 345, 350, 355, 360. Those components may be coupled using network links, and may be co-located, or may be situated at different locations.

Supplied content is provided by UCDP 340 to consumer devices via network 370, which may include the Internet, the Internet cloud, and/or other wired or wireless communication links, such as cable multisystem operator (MSO) links, cellular telephone system links, and/or other network links. The consumer devices can include, for example, wifi connected netbook 380, cellular connected smart phone 385, and cable/set top box-connected LCD TV 390, and the like.

In an exemplary operation, a consumer orders a movie for viewing on the TV, such as using a TV user interface designed to have a distinctive look and feel, realized through the use of certain defined design elements, element placements, and sequences of steps to be performed to obtain desired results. Once ordered, the movie may default or be selected to be downloaded for later viewing, for example using a digital video recorder (DVR) 395. Alternatively, the movie may default or be selected to be streamed to the TV.

If the delivered movie is streamed, the consumer may choose to stop viewing the movie and arrest the content stream, to be resumed later. When desired, the consumer can use the TV user interface to restart the streaming and resume viewing the movie on the TV. Alternatively, the consumer may choose to resume viewing using a different device, such as netbook 380. To do so, the consumer can restart viewing, preferably using a netbook user interface that has a look and feel similar to the TV user interface. UCDP 340 will then stream the movie to the netbook instead of to the TV. Alternatively, the consumer may choose to resume viewing using smart phone 385, and can restart viewing using a smart phone user interface that preferably has a look and feel similar to the TV user interface, and UCDP 340 will then stream the movie to the smart phone. UCDP 340 keeps track of the movie being viewed, the devices to which it is streamed, at what point the stream is arrested and resumed, and the like. UCDP 340 can store different versions and formats of the same content, appropriate for viewing on different devices. UCDP 340 also determines and selects the appropriate content version based on the consumer device to which the content is being delivered, and selects the appropriate communication system via which the content will be delivered.

Using UCDP 340, viewing information can be monitored, stored, and used for determining revenues to be collected from the consumer. Viewing information can also be used to determine at least in part monies to be paid to the content supplier. In addition, viewing information can also be aggregated with other information, pertaining to the same and/or other consumers, and analyzed in any desired manner for use in any of a variety of applications.

In an embodiment, UCDP 340 can be used to authorize access by a consumer to video, graphic, text, and/or audio content and the like. Authorization can be implemented, for example, using a registration process that includes collecting information from a consumer such as name, address, setting up payment options such as automatic charges to a credit card, automatic withdrawals from a bank account, periodic billing, etc. Registration can also include selection of a username and password for use in authenticating a consumer to access content using different devices. Authorization may similarly occur via, for example, biometric, such as facial, recognition, and further such biometric recognition may allow for particular devices to behave in a manner tailored to the recognized user with respect to accessing the content, i.e., an IPTV may behave in a manner akin to a tablet computer, if that is the recognized user's recorded preference; and/or may allow for a first device of that user to be mirrored to a second device of that user, i.e., a tablet computer of that user may be mirrored to a television of that user and, if the television is so-enabled, the television may thus be navigable using the user's finger and may otherwise behave as, and have access to the content of, the tablet computer. Such biometric recognition may be performed by any available means, including, but not limited to, security sensors, sensors associated with the device to be accesses (such as those sensors associated with Microsoft's Kinect), or the like.

Once authenticated, in an exemplary operation the consumer can download, view, or otherwise access the content on or onto one or more devices from the network, the cloud, a peer-to-peer location, a direct access point, or the like, such as using desktop and laptop computers, smart phones, set top boxes, netbooks, televisions, and the like, in compliance with applicable laws, rules, agreements, and guidelines. Downloaded content is then available for local access at the convenience of the consumer. Alternatively, UCDP 340 can stream content to consumer devices for viewing in real time, such as via a broadband connection.

Further, once authenticated, the user's content access may be tracked and measured, such as in the cloud/network 370. For example, the usage of a “television anywhere” offering by a particular user within a certain demographic, by a group of users, or by all users, may be tracked by content, content type, time, revenue, or the like. Needless to say, such tracking in accordance with the present invention will solidify targeted advertising opportunities, by way of non-limiting example.

Varying types and levels of service may be provided in accordance with the herein disclosed methods and systems. Accessible content may include, without limitation, TV programming, movies, and other video, static content such as text and/or graphics, audio content, and the like. Content may be provided in accordance with a user selection of an individual item, or a group of associated items such as a series, or a group of otherwise unassociated items, in any combination, and priced accordingly.

Access to content can be provided to various types and quantities of consumer devices. For example, access may be provided to a single device, or to a plurality of a select type of device, or to a plurality of devices of different types, or any combination thereof, and priced accordingly.

Access to content may be provided without advertising, or can include various levels of advertising and/or sponsorships, and priced accordingly. Pricing can also be modified in accordance with certain usage parameters or other criteria. Pricing structures can include different pricing levels based, for example, on various levels of usage, or on access to various types of content, and the like. Pricing can also be varied in conjunction with promotions of select content.

In an exemplary implementation, arrangements for providing unified content delivery services can be made in conjunction with a consumer purchase at a point of sale, such as the purchase of a viewing device. For example, the purchase of a new TV, smart phone, or computer may include, or may provide a credit applicable to, select content delivery services.

Various arrangements can be implemented to charge customers for access to content. Such arrangements can include, for example, pricing content based on consumer access to individual items, series of items, and/or collections of items, in any desired combination. Pricing can be modified based on the number of times a content item or group of items is accessed. Access can be provided either with or without limitations with regard to one or more pre-determined time periods in which access is available, such as access at any time during a determined time period, such as a week or a month. Access can also be provided based on a duration of access of an item or group of items, such as a purchase of a number of minutes or hours of viewing time that can be used at the convenience of the consumer. Accessibility features can be combined in various ways to provide standard or customized groups of accessibility features.

Pricing can be based on periodically incurred charges, such as monthly subscription fees. Alternatively, pricing can be based on access to individual selected items or groups of items. Or, pricing structures can be implemented based on combinations of periodic payments and individual payments.

For streaming content, pricing structures can be based, at least in part, on the frequency, duration, and time of access of selected streaming content or predefined content bundles, or the like. For downloadable content, pricing structures can be based on the size of the selected downloaded content, or predefined content bundles, or the like.

Pricing structures can also be based on other parameters of the accessed content, such as the subject matter, author, artist, producer, studio, label, publisher, age of the content (e.g., first run, best seller list, classics, public domain, etc.), resolution, quality, rating, and/or other parameters.

Similar to the manner in which customer pricing can be set up in various ways and based on various parameters, different arrangements can also be set up to provide payments to content suppliers. Content supplier payments may be based on periodically due payments, such as monthly licensing fees. Alternatively, payment can be based on actual consumer access to individual items selected for viewing by consumers. Content supplier payments may or may not be based on and closely aligned with, at least in part, the prices customers paid for viewing the supplied content.

For example, for streaming content, supplier payment structures can be based on the frequency, duration, and time of consumer access of selected streaming content or predefined content bundles. For downloadable content, payment structures can be based on the size of the downloaded content, or predefined content bundles, or the like. Payment can be based on the elapsed time spent by each subscriber viewing selected streaming content, accrued by day or by month for example, and allocated in any desired manner among the content suppliers. For downloaded content, supplier payments may be made in accordance with the amount of time each subscriber has spent accessing the content they select. Supplier payments may also be based at least in part on consumer access to individual items, series of items, and/or collections of items. Payments can be based on the number of times a content item or group of items is accessed, time periods in which access is available, duration of access. Supplier payments can also include periodically due payments, such as monthly licensing fees. Payment structures can also be based on other parameters of accessed content, such as the subject matter, author, artist, producer, studio, label, publisher, age of the content (e.g., first run, best seller list, classics, etc.), resolution, quality, rating, and/or other parameters.

Various other features may be implemented in UCDP 340 for providing unified content access services to users including, tracking and analyzing consumer content selections and other usage parameters. Information gathered and analyzed can be used, for example, to provide suggestions and recommendations to consumers based on their previous content selections and access preferences, or based on the selections and preferences of one or more groups of consumers having similar characteristics.

In an exemplary implementation, biometric authentication can be used instead of or as an alternative to a user ID/password for simplified subscriber authentication, such as authentication based on the output of a fingerprint scanner. For example, a camera may be used to collect biometric information, such as body shape, for example.

Social media features or interfaces to social media sites may be included in UCDP 340. Such social media features and interfaces can allow the posting of comments, reviews, and the like by consumers, and/or distribution of, or permitting access to, such comments, etc., to consumers' contact lists, for example.

Search features or interfaces to search engines may be included in UCDP 340, for example, to identify content based on song lyrics, movie and television dialog, and the like, such as in response to a query submitted by a consumer.

In addition, ancillary revenue sources may be identified based on data collected from consumers. For example, consumer information may be collected based on registration information, authentication information, and information collected in surveys, promotions, and the like. Such information may include, without limitation, a subscriber's age, gender, and other personal and/or household attributes. Content usage data can be associated with the subscriber. Such information can be analyzed, aggregated, classified, manipulated, and used in numerous ways. Exemplary uses of such information can include but are not limited to presenting targeted advertisements to the consumer, assembling and offering content bundles based on usage patterns and/or one or more consumer profiles based on consumer characteristics.

Thus, UCDP 340 can be used to service the digital media access needs of consumers, advertisers, and content suppliers more effectively than is possible in the prior art. For example, UCDP 340 can be used to enable publishers to charge for individual online articles or other online offerings, such as news, or certain categories of information such as sports, business, investment markets, and the like, which in the prior art may have been difficult to charge for, or which may have had only a modest readership. Consumers can be charged for accessing such content, and viewership may be increased, by bundling such content with other content from the same or other content suppliers in content packages. Such packages can be customized for individual consumers based on their usage patterns, or can be standardized for consumers fitting predefined consumer profiles based on select consumer characteristics.

In an exemplary embodiment, UCDP 340 can provide to individual content creators a venue by which they can effectively monetize their own works. Moreover, the UCDP 340 operator can provide centralized, unified negotiation services to content creators, for example, to negotiate licensing fees from other content providers such as websites. In an exemplary operation, the UCDP 340 operator can provide to content suppliers information gleaned from the system, such as which content items, series of items, types, categories, and the like are most popular, or which can command the greatest prices, or which bundling combinations result in the greatest revenues, or the greatest number of viewers, or the greatest number of views. Content suppliers can then use such information to enhance their offerings, for example, through other content delivery pathways, such as hardcopy magazines, books, theater showings, and the like.

UCDP 340 can thus facilitate consumer purchases of periodic subscriptions, subscriptions of limited duration, such as unlimited use for a day or a week, and single works such as articles, songs, and shows from a plurality of content suppliers, all through one unified platform. The service can simplify content delivery via different modes, such as via a cable to a computer and via a cellular system to a smart phone. In an exemplary operation, Content suppliers can coordinate delivery of both hardcopy content, such as newspapers and magazines, and online content, such as content delivered via UCDP 340. Content can be supplied through different means, monitored, and coordinated. For example, subscribers to hardcopy editions of newspapers and magazines may be offered discounted or free access to the online edition of the same or associated content. Conversely, subscribers to select content delivered via UCDP 340 can be offered subscriptions to hardcopy editions of the same or associated content.

Combined hardcopy and online subscription offerings may be more enticing to consumers than either type of offering alone, thereby increasing the viewership and the number of views of substantive content. Increased substantive content views results in more views of advertising content. Those increased advertising views can be achieved at a relatively low marginal cost of delivery, thereby driving down the total cost per thousand views (CPM) of an advertisement and enhancing the value of the advertising. Accordingly, UCDP 340 may allow its operator to charge advertisers enhanced fees for placing advertising content, in addition to charging consumers for access to the associated substantive content.

UCDP 340 also facilitates central monitoring and oversight of content delivery by the UCDP operator. Accordingly, for example, intellectual property infringements committed by content suppliers can be identified and addressed uniformly and aggressively. Such content monitoring and addressing of identified infringements can provide yet another source of revenue for the UCDP operator.

Consistent interfaces between different access modes can enhance ease of use of various content delivery services, making it easier for consumers to access and enjoy substantive content. In addition, payment can be aggregated, unified, and greatly simplified for access to a plurality of content offerings, accessed using a plurality of devices and types of devices, using a plurality of different communication systems.

Many different concepts having to do with whether and how to charge for content can be tested in trial programs. Such trials can be used to measure and analyze consumer behavior with regard to the frequency, timing, duration, and variety of viewed content. In an exemplary operation, such information can be used to determine the effectiveness of targeted advertising, for example. Trials and regular programming can include monitoring of content viewing by consumers, solicitation of viewer comments, automatic or requested presentation of viewer surveys, solicitations of viewer ideas for desired services and service formats, improvements to existing services, and the like.

Similarly, content suppliers can be polled for their ideas regarding ways to package, present, and charge for content, and their ideas can also be tested in trials. Supplier ideas for purchase or licensing of their content can also be communicated to the UCDP operator the via the system, and negotiations for content to be included for distribution via the UCDP 340 can be conducted via the system.

UCDP 340 can also be used to target advertising to select geographic areas, such as through the use of electronic coupons and personalized shopping offerings by specific brick-and-mortar retail outlets. The known location of a stationary viewer, such as may be obtained from subscriber records for example, can be used to target advertising to consumers situated within a select distance of an advertiser's location. In addition, the location of a mobile viewer can be obtained, for example, based on the locations of cellular towers providing mobile access to a subscriber's mobile device, such as a smart phone. That location can be used to deliver mobile ads, such as ads that pertain to retail outlets that are within a select distance of the subscriber at a particular point in time. For example, a consumer watching a TV show on a smart phone while sitting on a park bench can be presented with advertising content for retail stores near that bench. Alternatively, a consumer reading an online magazine can be presented with magazine page contents that are dynamically modified to include a graphical or video advertisement for nearby retail stores.

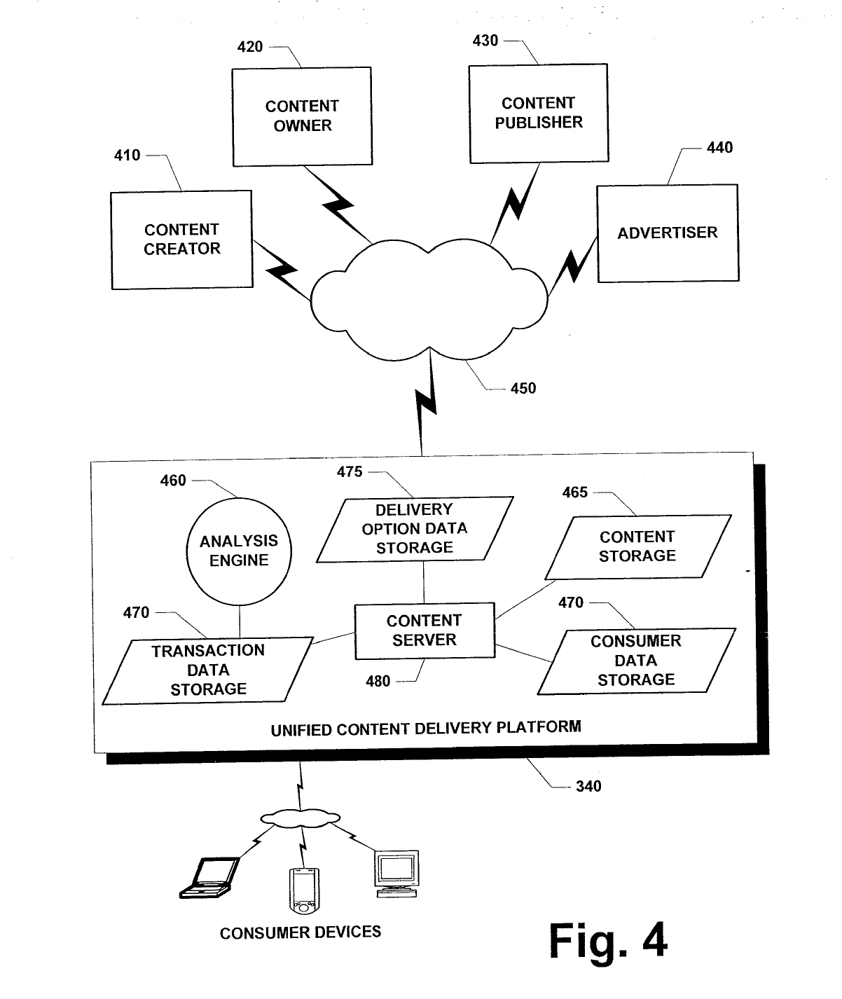

FIG. 4 is a block diagram illustrating exemplary components of UCDP 340 for use in obtaining content from suppliers and delivering supplied content to consumers. Exemplary content suppliers include content creator 410, content owner 420, content publisher 430, and advertiser 440, although other suppliers and supplier types may be used to supply content for delivery via UCDP 340. Content may be supplied to UCDP 340 via network 450, which may include the Internet. Content may also be supplied to UCDP 340 by other means, such as by delivering a storage device storing the content from a supplier to the UCDP operator, for example.

As shown, UCDP 340 can include content storage device 465 for storing content supplied by the content suppliers, and providing the content for delivery to consumers, such as in response to consumer requests for access to substantive content. Content storage may also store collateral content, such as advertising content which may be delivered in conjunction with the requested substantive content. Consumer data storage 470 stores data collected from consumers, such as registration information, credit or bank account information provided for payment of charges, and personal and/or household information supplied, for example, in response to customer surveys and the like. Consumer data storage 470 can also obtain and store information for use in content delivery, such as addressing information of the device to which the content is to be delivered, the device's capabilities, geographic location, and the like, which may be obtained for example from the device used to request access to content. UCDP 340 can also include delivery option data (DOD) storage 475 and content server 480. Content server 480 obtains content from content storage 465 and delivery information from consumer data storage 470, and delivers content to the viewing device in accordance with information obtained from DOD storage 475. Information of such a data transaction can be stored in transaction data storage 470. Transaction data can be analyzed by analysis engine 460. Analysis engine 460 can also use raw and/or analyzed transaction data for various purposes in accordance with the herein disclosed methods and systems, including but not limited to determining charges to be billed to content viewers, determining fees to be paid to content suppliers, determining content configuration bundles to be used in trial programs or implemented in regular offerings, etc.

In an embodiment of the present invention, UCDP 340, may also take into account ratings regarding the consumption of the media being provided. Such ratings may be provided in real time, and may take the form of providing the number of viewers of particular media, for example. For example, the UCDP 340 may provide a particular user with information regarding the consumable habits of other users to which access may be gained by the local user's UCDP 340. Thus, for a local user of UCDP 340 watching television, and a particular television show, for example, the number of third party viewers of that same television program may be provided to the user. In this way, as the local user moves from television program to television program, the number of other viewers consuming that particular program may be displayed to the local user.

Google® trends may also be used as a ratings generator for web accessible content, including television programming. Google® trends may chart how often a particular search term is entered relative the total search volume across various regions of the world, and in various languages. The display of Google® trends may illustrate a horizontal axis representing time, and a vertical representing how often a term is searched for relative to the total number of searches, globally. The data may be displayed with popularity broken down by region, city and/or language, for example. It is also possible to refine by region and time period. Google® trends may also allow comparison of the volume of searches and/or consumption between two or more terms/media. The above may provide data for ratings in accordance with the present invention. For example, Google® trends may be used to compare a certain televised media program against a baseline, such as all televised media programs or all media in a particular field, thereby allowing for calculation of a rating relative to other media. Additionally, an interpolation of trends against known qualities of a certain media increases the level of detail of the popularity of that media. Further, for example, if consumption of a certain program is known, and a second program has half the viewership of the first, it can be interpolated that searches for the second program are half in number of those for the first, and thus the second program may be deemed to be half of the first in overall popularity.

Such ratings may be provided to the user through the UCDP 340, either directly on the device itself or as an overlay on the television program being consumed, for example. In addition to, for example, the percentage of users watching the program versus the total number of users accessible by the UCDP 340, the overlay information may also provide more specific information regarding the local and third party users' time logged on at least one particular program, the current status of a particular user, and/or any feedback which may have been provided by at least one user, for example. The status of a user may include whether or not the user is within viewing distance of the television, for example. Such information may be gathered by a remote sensing device as described in provisional patent application Ser. No. 61/367,536, entitled Passive Demographic Measurements Apparatus, which is herein incorporated by reference. Similarly, any user registered with the system may provide feedback through the system, such as indicating likes and dislikes of the programming being provided, and/or comments regarding the programming such as in a blog format, for example.

As would be understood by those skilled in the art, such a display of information and interactivity between users may take the form of a social network. Such a social network may be independently run within the system of the present invention and/or may be linked with existing social networks. As used herein, the term “social network” refers to a concept encompassing an individual's personal network of friends, family, colleagues, coworkers, and the subsequent connections within those networks. A social network, for example, can be utilized to find more relevant connections for a variety of activities, including, but not limited to, dating, job networking, service referrals, content sharing, like-minded individuals, activity partners, or the like.

An online social network, for use in the present invention, refers to a person's set of direct and/or indirect personal relationships, including real and virtual privileges and permissions that users may associate with these relationships. Direct personal relationships refers to relationships with people the user communicates with directly, including family members, friends, colleagues, coworkers, and other people with which the person has had some form of direct contact, such as contact in person, by telephone, by email, by instant message, by letter, or the like. These direct personal relationships are sometimes referred to as first-degree relationships. First-degree relationships can have varying degrees of closeness, trust, and other characteristics.

In addition to the sensors discussed hereinabove, a local device provided to the consumer interconnected with the UCDP 340 may detect the content being consumed by the user through detection of the signal after a cable box, for example, and/or direct detection of a user's remote control. In either instance, the local device may enable the collection of consumer media consumption by the UCDP 340 without access to the data collected by the provider of the media, such as, for example, a cable operator. Similarly, information regarding the user's consumption of media may be obtained directly from the edge servers of a cable operator, for example, and may be accessed by the local device and/or directly by the UCDP 340.

To facilitate such interaction, the UCDP 340 may include a network interface which may further include circuitry for accessing one or more networks, and may be constructed for use with one or more communication protocols and technologies including, but not limited to, global system for mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, Bluetooth™, infrared, Wi-Fi, Zigbee, or any of a variety of other wireless communication protocols. The UCDP 340 may optionally communicate with a base station, or directly with another computing device.

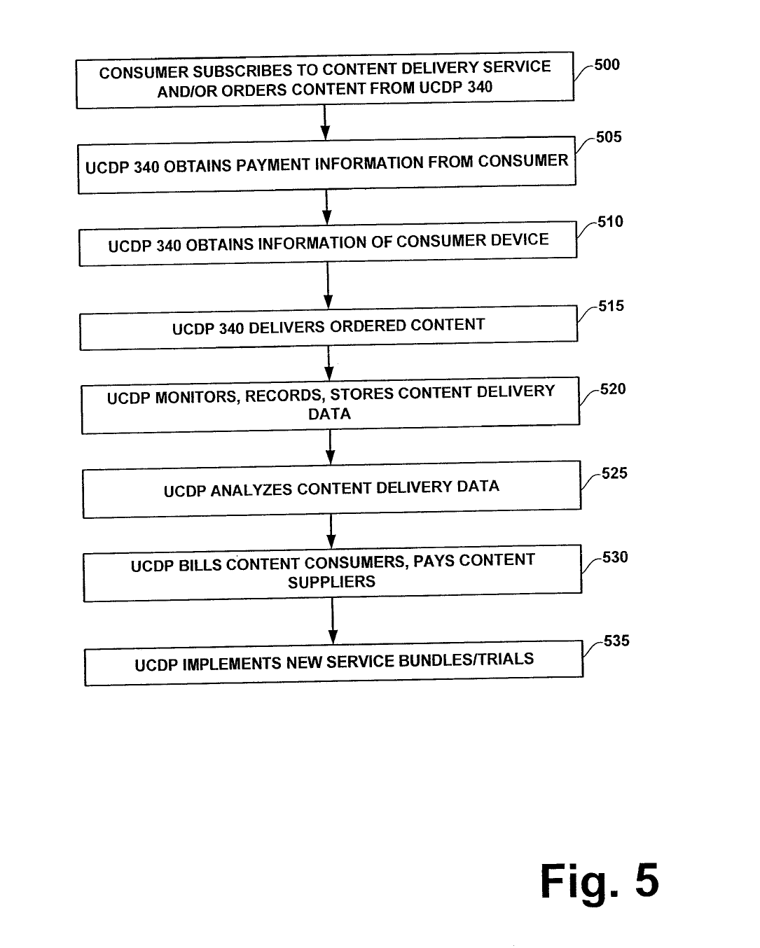

Utilizing at least the information regarding the local user's consumption of media and/or coupled with the ratings information derived from the usage of at least one third party user, the present invention may also deliver targeted advertising, along with the ratings information provided, to the local user. Such targeted advertising may be targeted to the local user based on the time of day the user most consumes a certain type of media, the location of the consumption of media, and/or the frequency by which a particular user consumes a particular type of media. Targeted advertising may also be based on sensor information, which may be collected by the present invention as discussed above, and may allow the system to determine whether or not at least one local user is actually watching the content being provided and tracked through the UCDP 340. For example, although a signal may be received by a local user, if the user is not present in the room visually demanding content such as TV, for example, may not have the desired impact upon the consumer of the television program. Thus, it may be determined that certain viewing hours recorded for the local user may have a lower advertising impact than other times when it may be determined that the local user is attentive to the delivered content. FIG. 5 is a flow diagram of a currently preferred implementation of providing content for viewing content by consumers in accordance with the herein described systems and methods.

In FIG. 5, a consumer accesses the UCDP to order content for viewing on a viewing device or for listening to on an audio device, 500. Alternatively, the consumer can complete a registration process to obtain access to content in accordance with terms of a subscription, and then select content to be accessed. The UCDP can obtain and confirm payment information from the consumer, 505. The UCDP obtains information of the audio or viewing device, 510, preferably automatically from the device, including but not limited to its display resolution and color capabilities, network(s) it can use to communicate, storage capacity, geographic location, and network address. The UCDP can then deliver the ordered content to the consumer device, 515, such as by downloading a file containing the ordered content for storage on that device or another storage device, such as a DVR, consumer network attached storage, etc. Alternatively, the UCDP can stream appropriate types of content, such as audio, video, and/or audio-video content, to the consumer device. The UCDP can monitor and store information pertaining to the delivery of the ordered content, 520. That information can be used in various ways in accordance with herein disclosed systems and methods, for example, to determine consumer charges and/or content supplier payments, to design new service bundles and/or trial services, and the like, 525. The UCDP can also be used to obtain consumer payments and/or deliver supplier payments, 530. The UCDP can also be used to implement the new service bundles and/or trials based on the analysis, 535.

The herein described systems and methods can be implemented using a wide variety of computing and communication environments, including both wired and wireless telephone and/or computer network environments. The various techniques described herein may be implemented in hardware alone or hardware combined with software. Preferably, the herein described methods are implemented using one or more programmable computing systems that can access one or more communications networks and includes one or more processors, storage mediums storing instructions readable by the processors to cause the computing system to do work, at least one input device, and at least one output device. Computing hardware logic cooperating, with various instruction sets are applied to data to perform the functions described herein and to generate output information. The output information is applied to one or more output devices. Programs used by the exemplary computing hardware may be implemented using one or more programming languages, including high level procedural or object oriented programming languages, assembly or machine languages, and/or compiled or interpreted languages. Each such computer program is preferably stored on a storage medium or device (e.g., solid state memory or optical or magnetic disk) that is readable by a general or special purpose programmable computer for configuring and operating the computer when the storage medium or device is read by the computer to perform the procedures described herein. Implementation apparatus may also include a computer-readable storage medium, configured with a computer program, where the storage medium so configured causes a computer to operate in a specific and predefined manner.

The various illustrative logic, logical blocks, modules, data stores, applications, and engines, described in connection with the embodiments disclosed herein may be implemented or performed using one or more of a general purpose processor, a digital signal processor (DSP), an application specific integrated circuit (ASIC), a field programmable gate array (FPGA) or other programmable logic device, discrete gate or transistor devices, discrete hardware components, or any combination thereof, able to perform the functions described herein. A general-purpose processor may include a microprocessor, or may include any other type of conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Further, the steps and/or actions described in connection with the features disclosed herein may be embodied directly in hardware, in a software module executed by a processor, or in a combination of the two. A software module may reside in RAM memory, flash memory, ROM memory, EPROM memory, EEPROM memory, registers, a hard disk, a removable drive, a CD-ROM, or any other form of storage medium known in the art. An exemplary storage medium may be coupled to the processor, such that the processor can read information from the storage medium. Alternatively, the storage medium may be integral to the processor. Further, in some aspects, the processor and the storage medium may reside in an ASIC. Alternatively, the processor and the storage medium may reside as discrete components. Additionally, in some aspects, the steps and/or actions of a method or algorithm may reside as one or any combination or set of instructions stored on a machine readable storage medium and/or a computer readable storage medium.

Those of skill in the art will appreciate that the herein described systems and methods are susceptible to various modifications and alternative constructions. There is no intention to limit the scope of the appended claims to the specific constructions described herein. Rather, the herein described systems and methods are intended to cover all modifications, alternative constructions, and equivalents falling within the scope and spirit of the appended claims and their equivalents.

1. (canceled)

2. A uniform content delivery platform apparatus comprising:
a network interface configured to provide communication with one or more consumer devices via a network;
a content storage configured to store content in a plurality of formats received from content suppliers via the network interface;
a consumer data storage configured to store consumer information;
at least one content server configured to provide content from the content storage to one or more consumer devices; and
an analysis engine configured to charge the consumer a fee based on at least one of the size of the content received by the one or more consumer devices and the elapsed time spent playing or displaying the content by the one or more consumer devices.

3. The apparatus of claim 2, wherein the at least one content server is further configured to provide content to the one or more consumer devices in a plurality of formats.

4. The apparatus of claim 3, wherein the at least one content server is further configured to select the format in which to provide content based on the consumer device requesting the data.

5. The apparatus of claim 2, further comprising:
a transaction data storage configured to store information pertaining to consumer transactions.

6. The apparatus of claim 5, wherein the transaction data storage is further configured to record information regarding the provision of content from the content storage to one or more consumer devices including at least one of the identity of the content transferred, the format of the content transferred, the identity of the consumer, the type of consumer device, and the time the content is transferred.

7. The apparatus of claim 2, wherein the analysis engine is further configured to analyze data to provide one or more of billing, rating, advertising, tracking, and payment functionality.

8. The apparatus of claim 2, wherein the fee is based on at least one of the amount of content received, the amount of content played or displayed, the elapsed time spent playing or displaying the content, and the number of advertisements played or displayed, on the one or more consumer devices.

9. The apparatus of claim 3, wherein the apparatus is configured to provide targeted advertisements based on at least one of consumer data, transaction data, a location of a consumer, and a location of a consumer device.

10. The apparatus of claim 9, wherein the apparatus is further configured to provide targeted advertisements only if it determines that a consumer is present to view the advertisements.

11. The apparatus of claim 2, wherein the analysis engine is further configured to pay content suppliers based on one or more of a flat fee, the format of the content provided, the identity of the content provided, the number of consumers accessing the content provided, and the number of times the content provided is accessed.

12. The apparatus of claim 2, wherein the apparatus is configured to provide a uniform consumer interface regardless of the type consumer of device being used to request or receive content.

13. The apparatus of claim 2, wherein the apparatus is configured to gather data regarding content consumption and to facilitate the display of information based on the gathered data to a plurality of consumer devices.

14. A method of providing content to consumers, said method comprising:
receiving content from a plurality of content providers;
storing the content electronically in a plurality of formats on a content storage;
receiving a request for content from a consumer device;
providing the requested content from the content storage via a content server to the consumer device based on their request; and
based on at least one of the size of the content received by the one or more consumer devices and the elapsed time spent playing or displaying the content by the one or more consumer devices.

15. The method of claim 14, further comprising:
selecting the format of the requested content based on the type of consumer device requesting the content.

16. The method of claim 14, further comprising:
recording data pertaining to at least one of requests from consumer devices and the provision of content to consumer devices.

17. The method of claim 14, wherein the fee is based on at least one of the amount of data received, the amount of content played or displayed, and the number of advertisements played or displayed on the one or more consumer devices.

18. The method of claim 14, wherein the content suppliers are paid based on one or more of a flat fee, the format of the content provided, the identity of the content provided, the number of consumers accessing the content provided, the elapsed time spent accessing the content provided, and the number of times the content provided is accessed.

19. The method of claim 14, further comprising:
determining that a consumer is present near the consumer device; and
sending targeted advertisements to the consumer device based on at least one of consumer data, transaction data, a location of a consumer, and a location of a consumer device.

20. The method of claim 14, further comprising:
providing a uniform consumer interface to consumer devices.

21. The method of claim 14, further comprising:
gathering data from a plurality of consumer devices regarding content consumption; and
facilitating the display of information based on the gathered data to a plurality of consumer devices.

22. The apparatus of claim 2, wherein the fee is based on the size of the content received by the one or more consumer devices.

23. The apparatus of claim 2, wherein the fee is based on the amount of content played or displayed by the one or more consumer devices.

24. The apparatus of claim 2, wherein the fee is based on the elapsed time spent playing or displaying the content by the one or more consumer devices.

25. The apparatus of claim 2, wherein the fee is based on the number of advertisements played or displayed by the one or more consumer devices.

26. The method of claim 14, wherein the fee is based on the size of the content received by the one or more consumer devices.

27. The method of claim 14, wherein the fee is based on the amount of content played or displayed by the one or more consumer devices.

28. The method of claim 14, wherein the fee is based on the elapsed time spent playing or displaying the content by the one or more consumer devices.

29. The method of claim 14, wherein the fee is based on the number of advertisements played or displayed by the one or more consumer devices.

30. A uniform content delivery platform apparatus comprising:
a network interface configured to provide communication with one or more consumer devices via a network;
a content storage configured to store content in a plurality of formats received from content suppliers via the network interface;
a consumer data storage configured to store consumer billing information;
at least one content server configured to provide content from the content storage to one or more consumer devices; and
an analysis engine configured to charge the consumer a fee based on the number of advertisements played or displayed on the one or more consumer devices.
